(19) United States
(12) Patent Application Publication
(10) Pub. No.: US 2012/0322559 A1
(43) Pub. Date: Dec. 20, 2012

(54) Math Master - A Math Card Game

(76) Inventors: YING LIU, Cheshire, CT (US); Jianfei Tang, Cheshire, CT (US)

(21) Appl. No.: 13/161,435

(22) Filed: Jun. 15, 2011

(51) Int. Cl. A63F 13/00; A63F 1/00

(52) U.S. Cl. 463/40; 273/299

(57) ABSTRACT

A mathematical card game and a method of play are provided. The cards consist of a suit of numeric cards, a wild card and a set of non-numeric cards. The numeric cards and wild card are mixed well and divided evenly among players. Each player places two cards face up in the center. The players use common mathematical operations to make mathematical relationships of the value of the four cards that equals a number determined prior to the game. The first player who correctly explains the relationship of the cards using the non-numeric card pile collects the entire four cards. The wild card can be any numbers from one to thirteen. When no successful match occurs, each player takes their two cards back. At the end of the game the player who has most cards wins.

### BACKGROUND

The presented math card game, Math Master, entails competitive play between players. It requires fast thinking and can be enjoyed by a wide range of ages including children and adults.

This invention integrates the broad range of mathematical operations and relationship into a card game to provide amusement to the players involved. The inventors herein have recognized that it would be desirable to have a card game that allows players to utilize their mathematical skills in a fun unique way. And by playing the math game the players practice the math operations repetitively, which further enhance the players' math skills as well strategic thinking skills.

A card game is designed to suit any venues in an inexpensive way. For example, school class room teaching, family and friend party and traveling in a car or airplane may prohibit use of an electronic device.

### SUMMARY OF THE INVENTION

An educational card game to provide amusement to players is disclosed. In embodiments, this invention addresses several aspects of learning in a simple and direct manner while being of low cost. The invention provides a game with a mathematical challenge; requires fast thinking; allows all players play at the same time during each round rather than players taking turns.

Over time, the repetitiveness of the mathematical principles will enhance the memory retention and the learning process while at the same time, a competitive social event is transpiring between the players which places the learning in an environment of enjoyment and leisure.

### BRIEF DESCRIPTION OF THE DRAWINGS

The invention is explained from the following detailed description and by referring to the illustrative drawings:

FIG. 1 shows the examples of a set of numeric cards used in the card game. The game comprising three sets numeric cards as shown in FIG. 1 and differentiated with blue, gray and red colors.

FIG. 2 shows the wild card can be used for any numbers from one to thirteen.

FIG. 3 shows the non-numeric cards for exemplary the calculation.

FIG. 4 shows a deck of numeric cards including the wild cards.

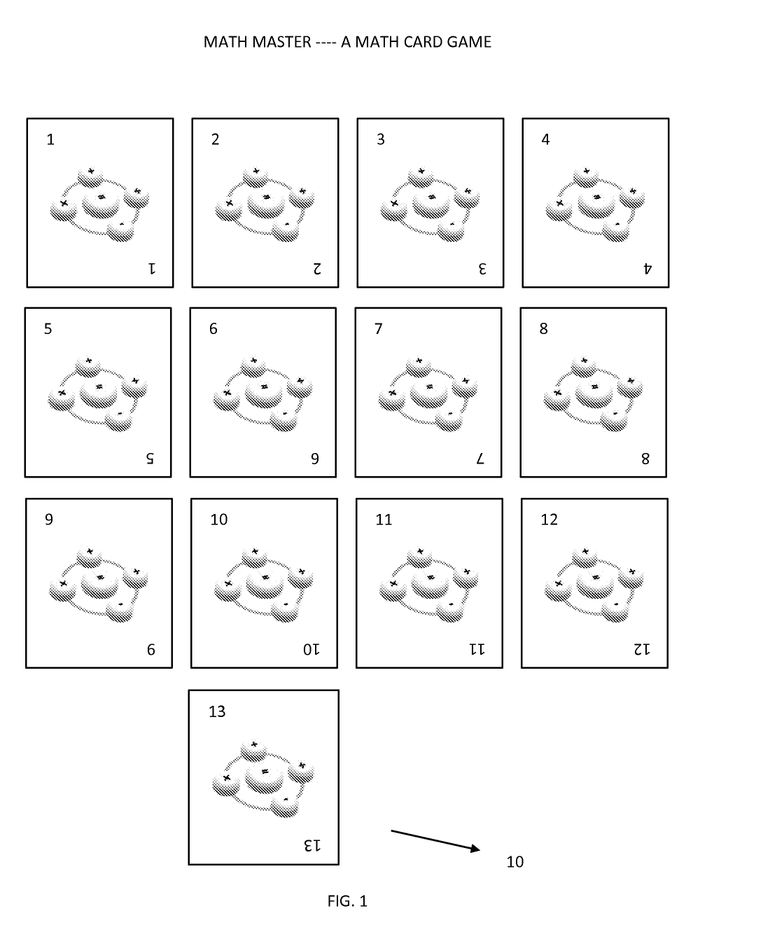

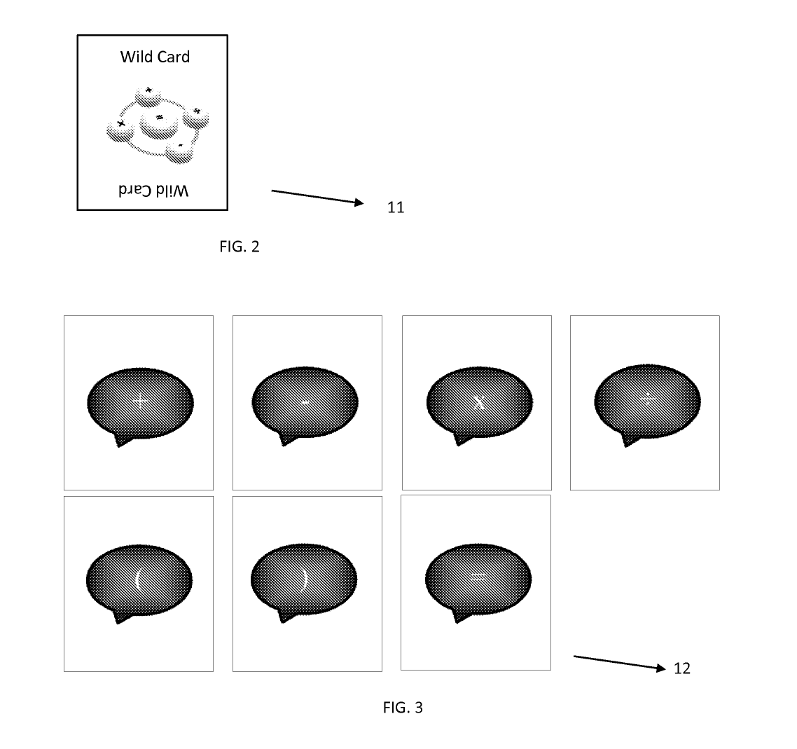

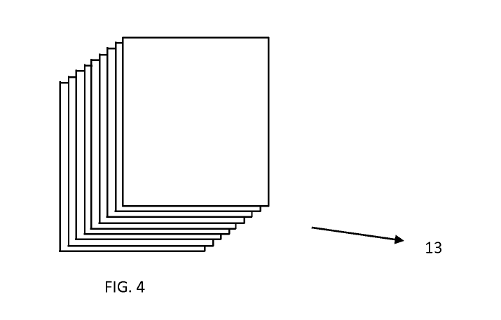

### REFERENCE NUMERALS IN DRAWINGS

10. Numeric Cards

11. Wild Card

12. Non-Numeric Cards

13. Deck of Numeric Cards that including the Wild Card

### DESCRIPTION

An educational card game comprises a Deck of Numeric Cards 10 and 13, a Wild Card 11 and a set of Non-Numeric Cards 12.

The Wild Card 11 mixed with a Deck of Numeric Cards 10. The deck of mixed card evenly divided into multiple suits 13 between players. Each numeric card has its value printed on the upper left corner and mirrored on the bottom right corner as evident on the Numeric Cards 10.

A set of Non-Numeric Cards 12 are provided as shown in FIG. 3, which has the plus, minus, multiply, division, parentheses, and equal signs printed at the center.

### OPERATION

This mathematical card game may be played with multiple players in numerous ways. The level of the player's math skills determines the level of playing. The basic two players' embodiment is as follows.

a) Shuffle the numeric cards 10 with the wild card 11 and divide them into two suits of twenty cards each facedown to the players 13.

b) Place the set of non-numeric cards 12 on the side.

c) Each player draws two cards from top of their perspective numeric card piles 13 and places them on the center of the table.

d) Players use mathematical operations comprising addition, subtraction, multiplication and division, in any order and with parenthesis, where is needed, and result in a value equal to 24. The wild card could be used for any numbers from one to thirteen.

For instance, if the value of the four cards are 2, 13, 6 and 8, the valid mathematical combination could be 2×13−(8−6)=24 or 2×13+6−8=24;

If the value of the four cards are 3, 12, 9 and wild card, the valid mathematical combination could be 12÷3×9−12 (wild card)=24 or 12+9−3+6=24 (the value of the wild card is 6);

e) The winning player is the first player stating the math equation correctly by placing the non-numeric cards into the math equation. The winning player collects all four cards and places them on the bottom of the pile. If the player does not correctly state the equations, the opponent wins the match and collects the four cards. If none of the players makes the statement that they can successfully explain the equation, each player will take back two cards and place them on the bottom of their piles.

f) Iteratively performing steps c) to e) until one of the players has all of the numeric and wild cards. The player having all of the playing cards is a winner of the card game.

In another embodiment of the card game, the rules as follows, for elementary math level players:

a) Shuffle the set of numeric cards 10 with the wild card 11 and divide all the cards into two suits of twenty cards each facedown to the players 13.

b) Take out the multiply and division cards from the non-numeric cards 12 and place the remaining cards 12 on the side.

c) Each player draws two cards from top of their perspective numeric card piles 13 and places them on the center of the table.

d) Players use mathematical operations comprising addition and subtraction, in any order and with parenthesis, and result in a value equal to 18. The wild card could be used for any numbers from one to thirteen.

For instance, if the value of the four cards are 2, 13, 5 and 8, the valid mathematical combination could be 2+13+(8−5)=18;

If the value of the four cards are 3, 13, 9 and wild card, the valid mathematical combination could be 13−3+9−1 (wild card)=18;

e) The winning player is the first player stating the math equation correctly by placing the non-numeric cards into the math equation. The winning player collects all four cards and places them on the bottom of the pile. If the player does not correctly state the equations, the opponent wins the match. If none of the players makes the statement that they can successfully explain the equation, each player will take back two cards and place them on the bottom of their pile.

f) Iteratively performing steps c) to e) until one of the players has all of the numeric and wild cards. The player having all of the playing cards is a winner of the card game.

The degree of difficulty of the game can be adjusted by removing certain numeric and non-numeric cards, modifying the value of the equation, adding or removing valid mathematical operators. For instance, the players can decide at the beginning what mathematical method will be used for this game. The player may decide to use only addition and subtraction for the game or use all four mathematic operations. Then the players may decide what equation value to use for the game. For instance, depending on the mathematical skill level, the players can choose the value from 24, 18, 16, or 12.

There are numerous additional ways to play the game as well as rules to add. One alternative is with multiple players to a maximum of four groups. For instance, the numeric cards 10 and the wild card 11 can be divided into four suits with ten each. Each player draws one card from their respective pile and places it on the center of the table to start calculation to the equation value.

### CONCLUSION, RAMIFICATIONS AND SCOPE

The reader can see that this is a unique card game that offers children and adult a fun way to learn and exercise mathematical operations and relationship.

While the description above contains many specifications these should not be construed as limitations on the scope of the invention, but rather as an exemplification of one preferred embodiment thereof many other variations are possible. For example, the game can be modified in terms of value of cards put into play and the types of acceptable mathematical operations allowed; the numeric cards may be increased to four sets. Also, the form of the game is not limited to card game; it also could be extended to video game, online game and others.

What is claimed:

1. A method of playing a card game comprising:
a) Providing a deck of cards having a plurality of cards organized in different suits with each suit comprising a plurality of cards with numeric values and a plurality of cards with mathematic operation symbols and a wild card;
b) Providing a plurality of players;
c) Shuffling said deck of numeric cards and wild card and dividing an equal number of the shuffled card to each one of plurality of players;
d) Determining the equation value and the mathematic operations according to the players' levels of math skills;
e) Placing equal number of numeric cards piles from each of the players to a maximum of four cards in the center;
f) Using multiple different pre-defined valid mathematic operations and relationships to achieve the result that successfully equate to a pre-determined equation value;
g) Assigning numeric values to the wild card and the wild card can replace any values on the numeric cards;
h) Announcing the successful match by correctly placing the non-numeric mathematic symbols cards into the math equation and the winning player collect the entire four cards;
i) Players incorrectly stating the math equations, the opponent collects the four cards;
j) In the event all players cannot successfully explain the mathematical relationship, each player takes back their own cards;
k) Repeating steps e) to j) until one player collects most of the numeric cards;

2. A card game comprising:
a) A deck of numeric cards comprising three sets of cards that are numbered from one to thirteen;
b) A wild card which can be used as any of numeric cards;
c) A deck of non-numeric cards comprising two sets of cards with mathematic operation symbols printed;
The numeric cards may be increased to four or more sets and the value of the cards can be extended to larger numbers Also, the players can add more mathematic operations into the game to increase the game level of difficulty;

3. The form of the game is not limited to card game; it also could be extended to video game, online game and others.
